(19) United States
(12) Patent Application Publication
(10) Pub. No.: US 2017/0145261 A1
(43) Pub. Date: May 25, 2017

(54) Plastic Binding Strip Jointing/Fusing Structure

(71) Applicant: Chian Yih Harng Co., Ltd., Taoyuan City (TW)

(72) Inventor: Yi-Chung Chiu, Taoyuan City (TW)

(21) Appl. No.: 15/220,447

(22) Filed: Jul. 27, 2016

(30) Foreign Application Priority Data
Nov. 20, 2015 (TW) 104218640

(51) Int. Cl. C09J 7/00; B32B 37/12

(52) U.S. Cl. CPC C09J 7/00; B32B 37/12; B32B 2037/1223; B32B 2323/04; B32B 2323/10; B32B 2405/00

(57) ABSTRACT

A plastic binding strip jointing/fusing structure includes a plastic binding strip having a plastic binding strip body. The plastic binding strip includes first and second ends connected to each other. The plastic binding strip further includes two longitudinal sides parallel to each other. Two mutually facing faces of the first and second ends form two overlapped contact faces. The first and second ends of the plastic binding strip body are heated between the two overlapped contact faces. Each overlapped contact face includes at least one hot melt engaging section and at least one non-melt section. The at least one non-melt section of each overlapped contact face is disposed on and blocks a lateral side of the at least one hot-melt engaging section. The at least one hot melt engaging sections of the two overlapped contact faces of the first and second ends engage with each other after hot melting.

### BACKGROUND OF THE INVENTION

The present invention relates to a binding strip structure and, more particularly, to a jointing/fusing structure for a thermoplastic plastic binding strip.

A plastic or metal binding strip is generally used to bind and pack a paper box receiving products. Alternatively, a plurality of boxes or products can be packed and fixed together by plastic or metal binding strips.

Currently, after binding one or more boxes or products with a polypropylene rigid plastic binding strip or a metal strip, a metal or plastic buckle is firstly extended through the binding strip which is then pulled tight, thereby fixing the one or boxes or products. Alternatively, two ends of a polypropylene rigid plastic binding strip can be fixed together by melting. However, the polypropylene rigid plastic binding strips and metal binding strips are liable to scratch paper boxes and, thus, cannot be used to pack delicate gift boxes and package boxes.

Thus, a need exists for a novel device that mitigates and/or obviates the above disadvantages.

### BRIEF SUMMARY OF THE INVENTION

The primary objective of the present invention is to use a heating head to provide rapid heating between two overlapped contact faces respectively of two ends of a plastic binding strip body made of polyethylene or polypropylene. Non-melt sections of two overlapped contact faces block opposite lateral sides of hot melt engaging sections during the melting procedure to prevent the heating head from moving outward and tearing the molten plastic material. Thus, the two overlapped contact faces of the two ends of the plastic binding strip body rapidly fuse with each other by the hot melt engaging sections, avoiding skewing and deformation and thereby achieving a proper jointing/fusing strength. Thus, the plastic binding strip can be a thin strip flexible enough to wrap and fix a gift box or a package box, avoiding deformation and damage to the paper board of the package box and preventing loosening and falling of objects in the package box.

To fulfill the above objective, the present invention provides a plastic binding strip jointing/fusing structure including a plastic binding strip having including a plastic binding strip body extending along a longitudinal axis. The plastic binding strip is elongated and includes first and second ends spaced from each other along the longitudinal axis. The plastic binding strip further includes two longitudinal sides parallel to each other and parallel to the longitudinal axis. The first and second ends of the plastic binding strip body are connected to each other. Two mutually facing faces of the first and second ends form two overlapped contact faces. The first and second ends of the plastic binding strip body are configured to be heated between the two overlapped contact faces. Each of the two overlapped contact faces includes at least one hot melt engaging section and at least one non-melt section. An area of the at least one hot melt engaging section of each of the two overlapped contact faces is larger than 50% of an area of each of the two overlapped contact faces. An area of the at least one non-melt section of each of the two overlapped contact faces is larger than 20% of the area of each of the two overlapped contact faces. The at least one non-melt section of each of the two overlapped contact faces is disposed on and blocks a lateral side of the at least one hot-melt engaging section of a corresponding one of the two overlapped contact faces. The at least one hot melt engaging sections of the two overlapped contact faces of the first and second ends engage with each other after hot melting.

In an example, the at least one hot melt engaging section of each of the two overlapped contact faces includes a plurality of hot melt engaging sections spaced from each other.

In an example, the at least one non-melt section of each of the two overlapped contact faces includes a plurality of non-melt sections spaced from each other.

In an example, the plastic binding strip body is made of polyethylene. The at least one hot melt engaging section of each of the two overlapped contact faces includes a plurality of hot melt engaging sections. The at least one non-melt section of each of the two overlapped contact faces includes a plurality of non-melt sections alternating with the plurality of hot melt engaging sections.

Each of the plurality of hot melt engaging sections can be rectangular.

Each of the plurality of hot melt engaging sections is an elongated shape extending along the longitudinal axis, extending in a transverse direction perpendicular to the longitudinal axis, or extending at an acute angle to the longitudinal axis.

The present invention will become clearer in light of the following detailed description of illustrative embodiments of this invention described in connection with the drawings.

### DESCRIPTION OF THE DRAWINGS

FIG. 1 is a perspective view of a plastic binding strip jointing/fusing structure of a first embodiment according to the present invention.

FIG. 2 is a perspective view illustrating use of the plastic binding strip jointing/fusing structure of FIG. 1.

FIG. 3 is an enlarged, perspective view of a portion of the plastic binding strip jointing/fusing structure of FIG. 2.

FIG. 4 is an exploded, perspective view of the plastic binding strip jointing/fusing structure of FIG. 3.

FIG. 5 is a cross sectional view illustrating heating of two ends of the plastic binding strip jointing/fusing structure of FIG. 3.

FIG. 6 is a view similar to FIG. 4, illustrating a plastic binding strip jointing/fusing structure of a second embodiment according to the present invention.

FIG. 7 is a view similar to FIG. 4, illustrating a plastic binding strip jointing/fusing structure of a third embodiment according to the present invention.

FIG. 8 is a view similar to FIG. 4, illustrating a plastic binding strip jointing/fusing structure of a fourth embodiment according to the present invention.

### DETAILED DESCRIPTION OF THE INVENTION

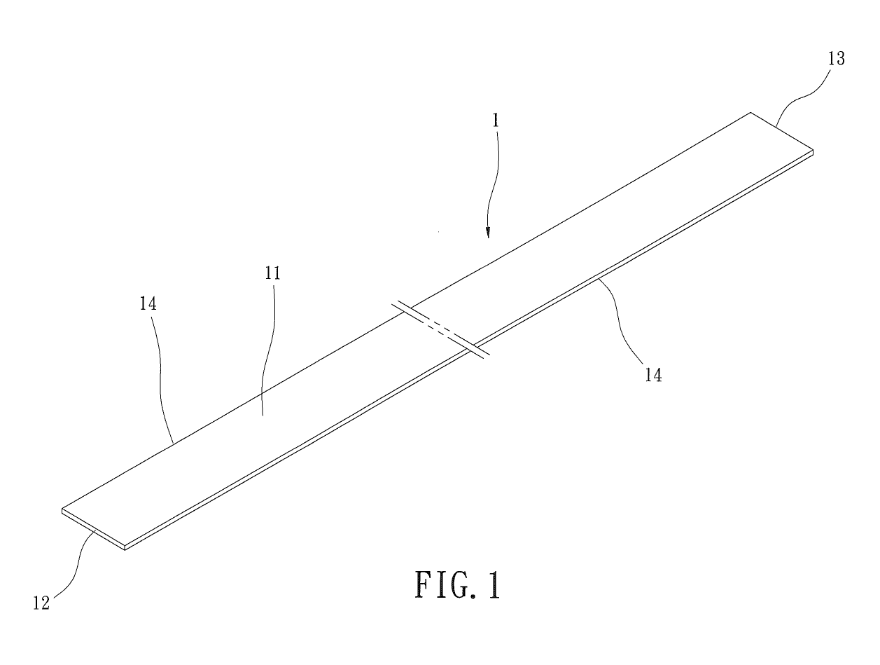

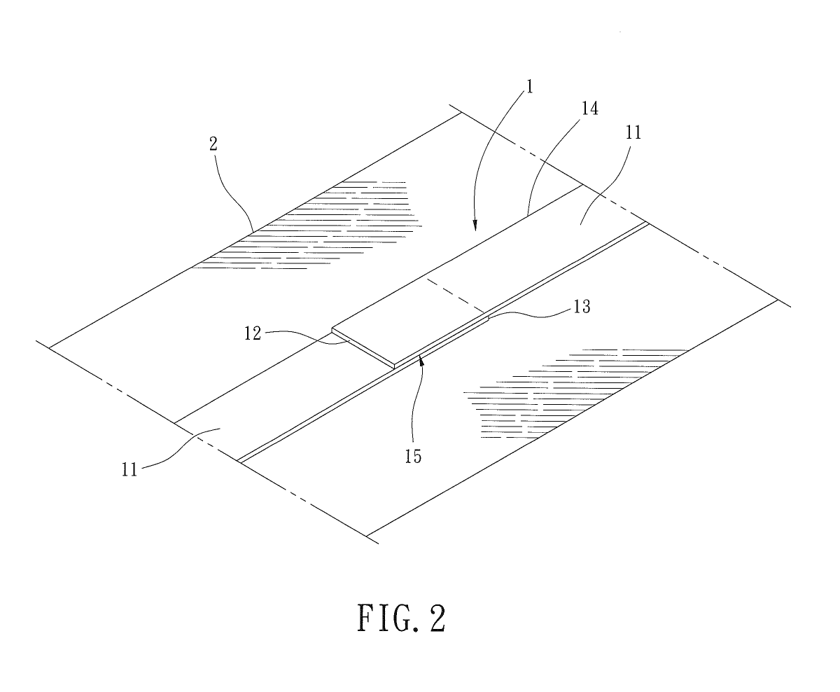

With reference to FIGS. 1 and 2, a plastic binding strip jointing/fusing structure of a first embodiment according to the present invention includes a plastic binding strip 1 is a continuous strip that is preferably coiled. In use, an end of the plastic binding strip 1 is pulled outward to a proper length for binding and packing. The plastic binding strip 1 is cut to form another end, and the two ends of the plastic binding strip 1 are connected together as a single piece by hot melting.

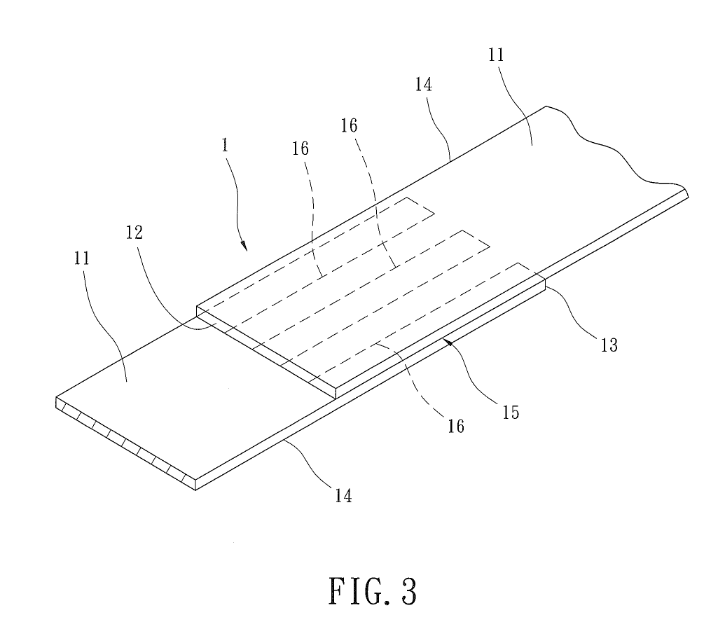

With reference to FIGS. 1-5, the plastic binding strip 1 is made of thermoplastic polyethylene or polypropylene and has a thickness of 0.1-0.5 mm or 0.1-1 mm. Furthermore, letters and/or figures can be printed on surfaces of the thin, flat plastic binding strip 1. In this embodiment, the plastic binding strip 1 includes a plastic binding strip body 11 extending along a longitudinal axis. The plastic binding strip 11 is elongated and includes first and second ends 12 and 13 spaced from each other along the longitudinal axis. The plastic binding strip 11 further includes two longitudinal sides 14 parallel to each other and parallel to the longitudinal axis. The first and second ends 12 and 13 of the plastic binding strip body 11 are connected to each other, such that two mutually facing faces of the first and second ends 12 and 13 form two overlapped contact faces 15.

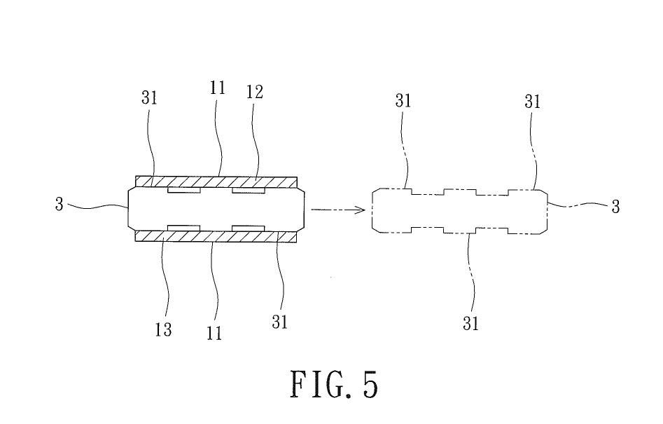

A heating head 3 is inserted between the two overlapped contact faces 15 and includes elongated upper and lower heating faces 31 for rapid heating the two overlapped contact faces 15 (FIG. 5). After heating, the heating head 3 is removed rapidly, and the first and second ends 12 and 13 are overlapped and pressed to engage with each other, such that each of the two overlapped contact faces 15 includes at least one hot melt engaging section 16 and at least one non-melt section 17. In this embodiment, each of the two overlapped contact faces 15 includes a plurality of hot melt engaging sections 16 spaced from each other and a plurality of non-melt sections 17 spaced from each other and alternating with the hot melt engaging sections 16. An overall area of the hot melt engaging sections 16 of each of the two overlapped contact faces 15 is larger than 50% of an area of each of the two overlapped contact faces 15. An overall area of the non-melt sections 17 of each of the two overlapped contact faces 15 is larger than 20% of the area of each of the two overlapped contact faces 15.

Thus, by using the upper and lower heating faces 31 of the heating head 3 to rapidly heat the two overlapped contact faces 15 of the first and second ends 12 and 13, the two overlapped contact faces 15 are formed with hot-melt engaging sections 16 and non-melt sections 17. The non-melt sections 17 of each of the two overlapped contact faces 15 block lateral sides of each hot-melt engaging section 16 of a corresponding one of the two overlapped contact faces 15 during the melting procedure. Thus, molten plastic material will not be pulled out when the heating head 3 is removed. Consequently, the hot melt engaging sections 16 of the two overlapped contact faces 15 of the first and second ends 12 and 13 are rapidly fused together, avoiding skewing and deformation while achieving a proper jointing/fusing strength. The plastic binding strip 1 is thin and flexible and can be used to bind a gift box or a package box 2, avoiding deformation of paper boards of the package box 2 resulting from forcible binding. Furthermore, loosening and falling of objects in the package box 2 is avoided. The product packing value is, thus, increased.

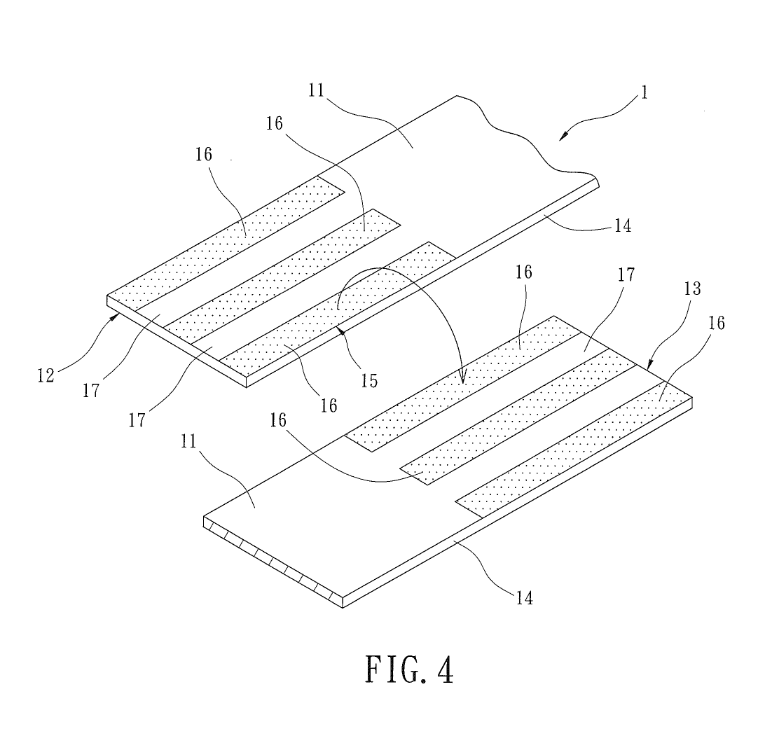

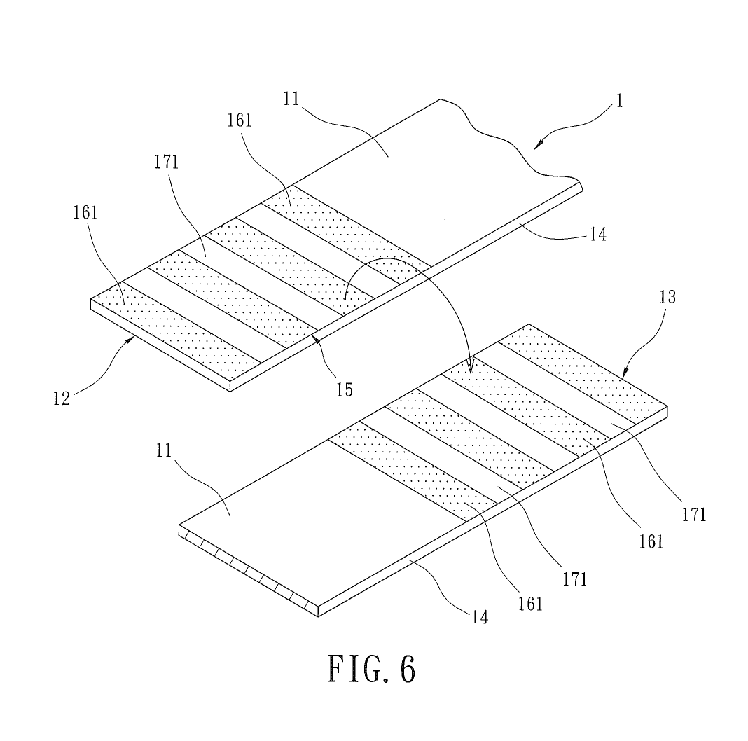

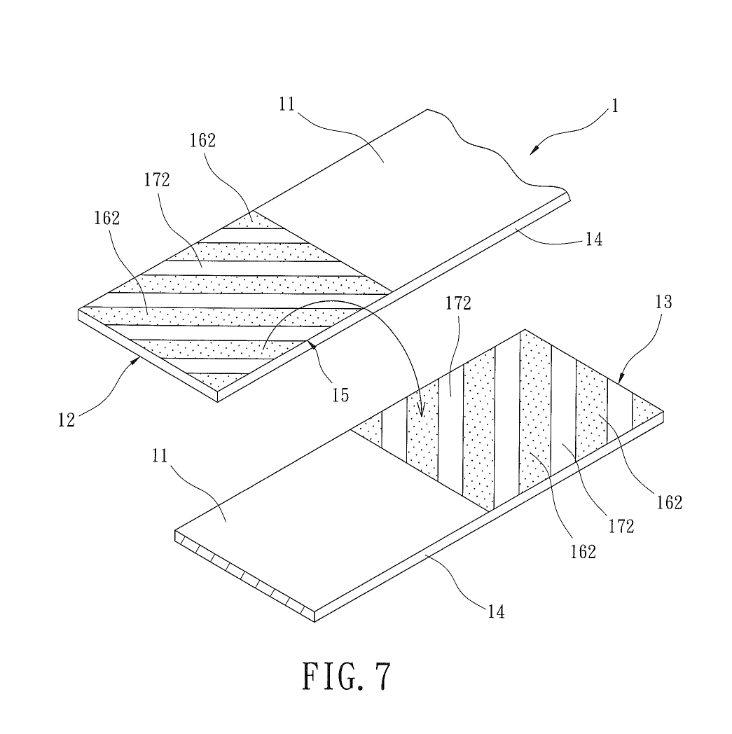

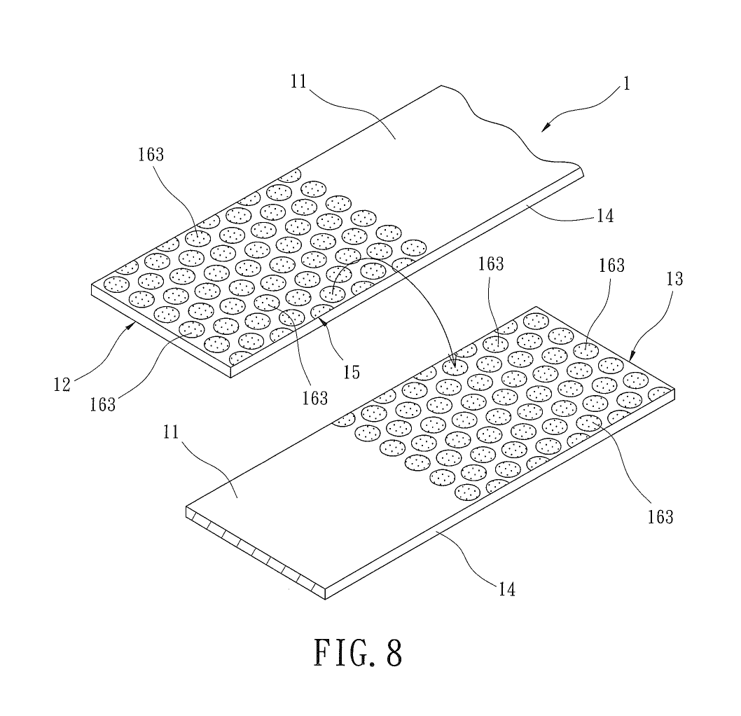

FIGS. 4-7 show various embodiments of the plastic binding strip 1 according to the present invention. In FIG. 4, each of the hot melt engaging sections 16 and the hot-melt sections 17 is an elongated shape (e.g., rectangular) extending along the longitudinal axis. In FIG. 6, each of the hot melt engaging sections 161 and the hot-melt sections 171 is an elongated shape (e.g., rectangular) extending in a transverse direction perpendicular to the longitudinal axis. In FIG. 7, each of the hot melt engaging sections 162 and the hot-melt sections 172 is an elongated shape extending at an acute angle to the longitudinal axis. In FIG. 8, each of the hot melt engaging sections 163 and the hot-melt sections 173 is a circle or a portion of a circle. Other geometric shapes can be used.

Although specific embodiments have been illustrated and described, numerous modifications and variations are still possible without departing from the scope of the invention. The scope of the invention is limited by the accompanying claims.

1. A plastic binding strip jointing/fusing structure, comprising a plastic binding strip including a plastic binding strip body extending along a longitudinal axis, with the plastic binding strip being elongated and including first and second ends spaced from each other along the longitudinal axis, with the plastic binding strip further including two longitudinal sides parallel to each other and parallel to the longitudinal axis, with the first and second ends of the plastic binding strip body connected to each other, with two mutually facing faces of the first and second ends forming two overlapped contact faces, with the first and second ends of the plastic binding strip body configured to be heated between the two overlapped contact faces, with each of the two overlapped contact faces including at least one hot melt engaging section and at least one non-melt section, with an area of the at least one hot melt engaging section of each of the two overlapped contact faces being larger than 50% of an area of each of the two overlapped contact faces, with an area of the at least one non-melt section of each of the two overlapped contact faces being larger than 20% of the area of each of the two overlapped contact faces, with the at least one non-melt section of each of the two overlapped contact faces disposed on and blocking a lateral side of the at least one hot-melt engaging section of a corresponding one of the two overlapped contact faces, and with the at least one hot melt engaging sections of the two overlapped contact faces of the first and second ends engaged with each other after hot melting.

2. The plastic binding strip jointing/fusing structure as claimed in claim 1, with the at least one hot melt engaging section of each of the two overlapped contact faces including a plurality of hot melt engaging sections spaced from each other.

3. The plastic binding strip jointing/fusing structure as claimed in claim 1, with the at least one non-melt section of each of the two overlapped contact faces including a plurality of non-melt sections spaced from each other.

4. The plastic binding strip jointing/fusing structure as claimed in claim 1, with the plastic binding strip body being made of polyethylene, and with the at least one hot melt engaging section of each of the two overlapped contact faces including a plurality of hot melt engaging sections, and with the at least one non-melt section of each of the two overlapped contact faces including a plurality of non-melt sections alternating with the plurality of hot melt engaging sections.

5. The plastic binding strip jointing/fusing structure as claimed in claim 4, wherein each of the plurality of hot melt engaging sections is rectangular.

6. The plastic binding strip jointing/fusing structure as claimed in claim 4, wherein each of the plurality of hot melt engaging sections is an elongated shape extending along the longitudinal axis, extending in a transverse direction perpendicular to the longitudinal axis, or extending at an acute angle to the longitudinal axis.
